(19) United States
(12) Patent Application Publication
(10) Pub. No.: US 2011/0188875 A1
(43) Pub. Date: Aug. 4, 2011

(54) AUTO DOCUMENT FEEDING DEVICE AND IMAGE SCANNING DEVICE

(75) Inventor: Hiroshi Nakayama, Shizuoka (JP)

(73) Assignees: KABUSHIKI KAISHA TOSHIBA, Tokyo (JP); TOSHIBA TEC KABUSHIKI KAISHA, Tokyo (JP)

(21) Appl. No.: 13/014,166

(22) Filed: Jan. 26, 2011

Related U.S. Application Data
(60) Provisional application No. 61/300,154, filed on Feb. 1, 2010.

(51) Int. Cl. G03G 15/20

(52) U.S. Cl. 399/69

(57) ABSTRACT

A fixing device comprises a fixing device comprising, a fixing body that contacts with a non-fixed toner on a recording medium, a pressing body that forms a nip between the pressing body and the fixing body, a first heater to heat the fixing body, a second heater to heat the pressing body and a control part that applies maximum electric power to the first heater and the second heater until the pressing body reaches a copy temperature when, although the fixing body reaches a copy temperature, the pressing body does not reach the copy temperature.

### CROSS-REFERENCE TO RELATED APPLICATION

This application is based upon and claims the benefit of priority from Provisional U.S. Application 61/300,154 filed on Feb. 1, 2010, the entire contents of which are incorporated herein by reference.

### FIELD

Embodiments described herein relate to an improvement of a warm-up time of a fixing device used for an image forming apparatus.

### BACKGROUND

As a fixing device to fix a toner image formed on a sheet, for example, there is a device to heat a fixing belt and a press roller to form a nip between them. In the fixing device to heat the fixing belt and the press roller, at the time of warm-up, the rising of the fixing device is quickened, and the warm-up time is shortened. In order to shorten the warm-up time of the fixing device and to save energy consumed in the warm-up, it is preferable that a time difference between a time required for the fixing belt to reach a ready temperature and a time required for the press roller to a reach a ready temperature is small.

### DESCRIPTION OF THE DRAWINGS

FIG. 1 is a structural view showing a color printer of an embodiment;

FIG. 2 is a structural view in which a fixing device of the embodiment is seen in an axial direction;

FIG. 3 is a block diagram showing a control system of the fixing device of the embodiment;

FIG. 4 is a table showing an example of control temperatures of the fixing device of the embodiment;

FIG. 5 is a timing chart showing a case where at the time of warm-up of the fixing device of the embodiment, a press roller reaches a ready control temperature before a fixing belt reaches an upper limit control temperature;

FIG. 6 is a graph showing the temperature change of the fixing belt and the press roller according to the timing chart of FIG. 5 of the embodiment, and the temperature change of the fixing belt and the press roller in comparative example 1;

FIG. 7 is a timing chart showing the time of warm-up of a fixing device of a comparative example;

FIG. 8 is a timing chart showing a case where at the time of warm-up of the fixing device of the embodiment, although the fixing belt reaches the upper limit control temperature, the press roller does not reach the ready control temperature; and

FIG. 9 is a graph showing the temperature change of the fixing belt and the press roller according to the timing chart of FIG. 8 of the embodiment.

### DETAILED DESCRIPTION

According to an embodiment, a fixing device comprises a fixing device comprising, a fixing body that contacts with a non-fixed toner on a recording medium, a pressing body that forms a nip between the pressing body and the fixing body, a first heater to heat the fixing body, a second heater to heat the pressing body and a control part that applies maximum electric power to the first heater and the second heater until the pressing body reaches a copy temperature when, although the fixing body reaches a copy temperature, the pressing body does not reach the copy temperature.

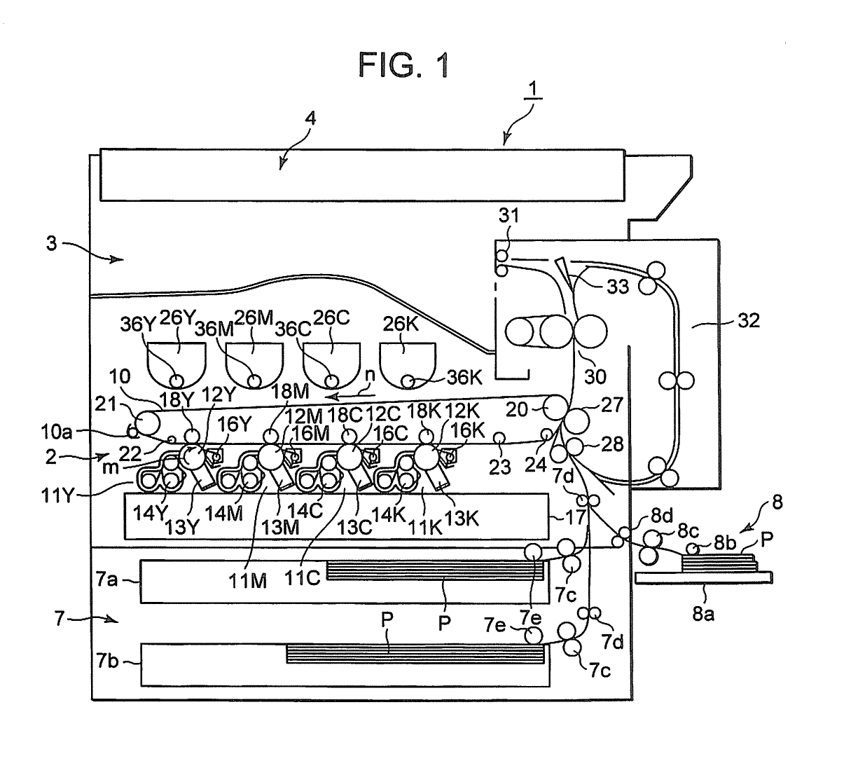

Hereinafter, an embodiment will be described. FIG. 1 is a schematic structural view of a color printer 1 as an image forming apparatus of the embodiment. The color printer 1 includes a printer part 2, a paper discharge part 3 to accumulate a sheet P as a recording medium discharged from the printer part 2, a scanner part 4, a paper feed device 7 to feed the sheet P and a bypass paper feed device 8.

The paper feed device 7 includes paper feed cassettes 7a and 7b, a pickup roller 7e and a separating roller 7c. The bypass paper feed device 8 includes a manual feed tray 8a, a manual feed pickup roller 8b and a manual feed separating roller 8c.

The printer part 2 includes four sets of image forming stations 11Y, 11M, 11C and 11K arranged in parallel along the lower side of an intermediate transfer belt 10. The image forming stations 11Y, 11M, 11C and 11K respectively include photoconductive drums 12Y, 12M, 12C and 12K. The respective image forming stations 11Y, 11M, 11C and 11K form toner images of Y (yellow), M (magenta), C (cyan) and K (black) on the respective photoconductive drums 12Y, 12M, 12C and 12K.

The respective photoconductive drums 12Y, 12M, 12C and 12K rotate in an arrow m direction. The image forming stations 11Y, 11M, 11C and 11K respectively include chargers 13Y, 13M, 13C and 13K, developing devices 14Y, 14M, 14C and 14K, and photoconductive cleaners 16Y, 16M, 16C and 16K around the respective photoconductive drums 12Y, 12M, 12C and 12K.

The respective image forming stations 11Y, 11M, 11C and 11K constitute process cartridges, and are respectively independently and integrally attached to and detached from a main body of the color printer 1.

The printer part 2 includes a laser exposure device 17. The laser exposure device 17 irradiates exposure lights corresponding to the respective colors to the respective photoconductive drums 12Y, 12M, 12C and 12K between the chargers 13Y, 13M, 13C and 13K and the developing devices 14Y, 14M, 14C and 14K.

The developing devices 14Y, 14M, 14C and 14K respectively perform developing by using two-component developers respectively including toners of Y, M, C and K and carriers. The printer part 2 includes toner cartridges 26Y, 26M, 26C and 26K respectively containing toners of Y, M, C and K, which are located above the respective developing devices 14Y, 14M, 14C and 14K. The toner cartridges 26Y, 26M, 26C and 26K include toner augers 36Y, 36M, 36C and 36K to convey the toners in directions toward the developing devices 14Y, 14M, 14C and 14K.

The printer part 2 includes a backup roller 20, a driven roller 21 and a first to a third tension rollers 22 to 24 which stretch the intermediate transfer belt 10. The intermediate transfer belt 10 rotates in an arrow n direction. The printer part 2 includes primary transfer rollers 18Y, 18M, 18C and 18K at positions opposite to the photoconductive drums 12Y, 12M, 12C and 12K through the intermediate transfer belt 10. The respective primary transfer rollers 18Y, 18M, 18C and 18K primarily transfer toner images on the respective photoconductive drums 12Y, 12M, 12C and 12K to the intermediate transfer belt 10. The respective photoreceptor cleaners 16Y, 16M, 16C and 16K remove and collect toners remaining on the respective photoconductive drums 12Y, 12M, 12C and 12K after the primary transfer.

The printer part 2 includes a secondary transfer roller 27 at a secondary transfer position opposite to the backup roller 20 through the intermediate transfer belt 10. The printer part 2 secondarily transfers the toner images on the intermediate transfer belt 10 onto the sheet P at a nip between the intermediate transfer belt 10 and the secondary transfer roller 27. The printer part 2 includes a belt cleaner 10a to clean the intermediate transfer belt 10 after completion of the secondary transfer.

The printer part 2 includes a manual feed transfer roller 8d to convey the sheet P from the bypass paper feed device 8. The printer part 2 includes a conveyance roller 7d and a register roller pair 28 to convey the sheet P from the paper feed device 7 or the manual feed conveyance roller 8d to the secondary transfer roller 27.

The printer part 2 includes a fixing device 30 downstream of the secondary transfer roller 27 along the conveyance direction of the sheet P. The printer part 2 includes a gate 33 downstream of the fixing device 30. The gate 33 distributes the sheet P in a paper discharge roller 31 direction or a reconveyance unit 32 direction. The paper discharge roller 31 discharges the sheet P to the paper discharge part 3. The reconveyance unit 32 again guides the sheet P in the secondary transfer roller 27 direction.

In the color printer 1, when a print process start, the chargers 13Y, 13M, 13C and 13K charge the respective photoconductive drums 12Y, 12M, 12C and 12K, and then, the laser exposure device 17 irradiates exposure lights to the respective photoconductive drums 12Y, 12M, 12C and 12K, and form electrostatic latent images corresponding to the exposure lights on the respective photoconductive drums 12Y, 12M, 12C and 12K. In the color printer 1, the respective developing devices 14Y, 14M, 14C and 14K visualize the electrostatic latent images on the respective photoconductive drums 12Y, 12M, 12C and 12K.

In the color printer 1, at the time of primary transfer, the toner images on the photoconductive drums 12Y, 12M, 12C and 12K are multiply transferred to the intermediate transfer belt 10. In the color printer 1, the toner images on the intermediate transfer belt 10 are secondarily transferred to the sheet P collectively.

In the color printer 1, the sheet P supplied to the paper feed device 7 or the bypass paper feed device 8 is conveyed to the secondary transfer position in synchronization with that the toner images on the intermediate transfer belt 10 reach the secondary transfer position. In the color printer 1, the fixing device 30 fixes the toner images to the sheet P, and the sheet is discharged to the paper discharge part 3 through the paper discharge roller 31. Alternatively, in the color printer 1, the sheet P fixed with the toner images is conveyed to the secondary transfer roller 27 through the reconveyance unit 32.

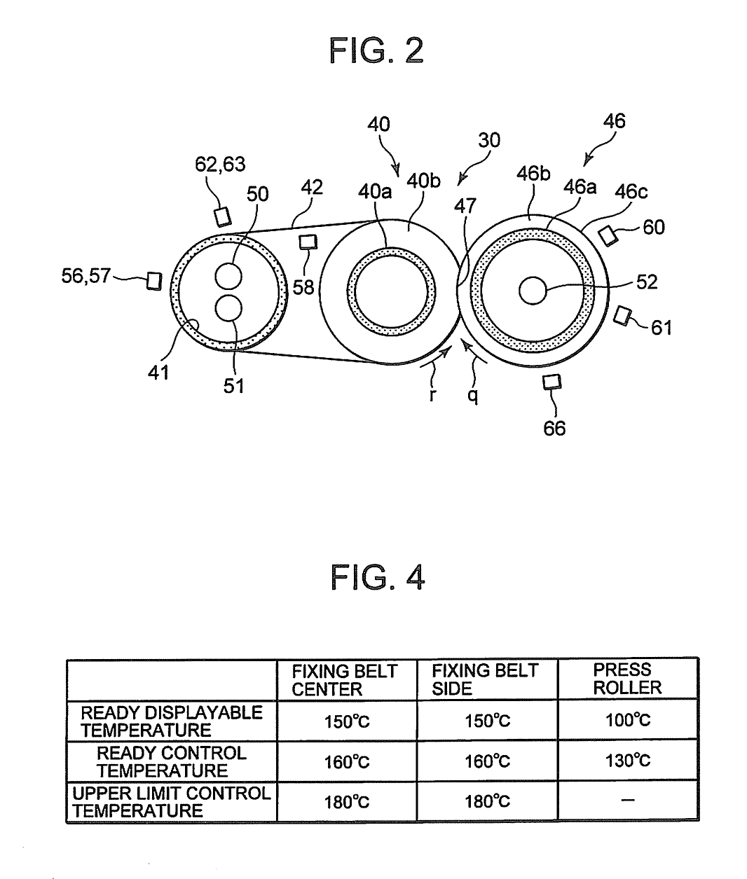

Next, the fixing device 30 will be described. FIG. 2 is a schematic structural view in which the fixing device 30 is seen in an axial direction. The fixing device 30 includes, as a fixing body, a fixing roller 40 and a heat roller 41 which are plural rotators, and further includes, as the fixing body, an endless fixing belt 42 stretched over the fixing roller 40 and the heat roller 41. The fixing device 30 includes a press roller 46 as a pressing body.

In the fixing device 30, the press roller 46 is brought into press contact with the fixing belt 42 supported by the fixing roller 40, so that a nip 47 having a specified width is formed between the fixing belt 42 and the press roller 46. The fixing roller 40 and the fixing belt 42 rotate in an arrow r direction, and the press roller 46 is driven by the fixing belt 42 and rotates in an arrow q direction.

The fixing roller 40 is formed by coating the outer periphery of, for example, a core metal 40a with a sponge rubber layer 40b of, for example, a thickness of 8 mm. The heat roller 41 is formed of an aluminum pipe of a thickness of, for example, 2 mm. The fixing belt 42 is formed by laminating, for example, a silicone rubber layer of a thickness of 100 μm and a release layer on the surface of a base member. The press roller 46 is formed by laminating, for example, a sponge rubber layer 46b of a thickness of 3 mm and a release layer 46c on the periphery of a core metal 46a.

For example the heat roller 41 includes a center heater lamp 50 of 500 W and a side heater lamp 51 of 500 W made of a halogen lamps as a first heater in the inside of the pipe. The center heater lamp 50 heats a center region, as a first region, of the heat roller 41. The side heater lamp 51 heats both side regions, as a second region, of the heat roller 41. The press roller 46 includes a press roller lamp 52 of, for example, 200 W in the inside of the core metal 46a. The maximum electric power required to turn on the center heater lamp 50, the side heater lamp 51 and the press roller lamp 52 is 1200 W in total.

The total maximum electric power which can be supplied to the center heater lamp 50, the side heater lamp 51 and the press roller lamp 52 is not limited. The center heater lamp 50, the side heater lamp 51 and the press roller lamp 52 can consume, as the maximum electric power, the power obtained by subtracting the power required for activating the system of the color printer 1 and the power required for rotating and driving the fixing roller 40 from the total power which can be used by the whole system of the color printer 1.

For example, a metal layer is provided on the heat roller, the fixing belt or the press roller, the metal layer is heated by an induced current generating coil, and the heat roller or the press roller may be heated.

The fixing device 30 includes, at the outer periphery of the fixing belt 42, a center thermopile 56 to detect the surface temperature of the center of the fixing belt 42 in a non-contact manner, a rear thermopile 57 to detect the surface temperature of the rear of the fixing belt 42 in a non-contact manner, and a front thermistor 58 to detect the surface temperature of the front of the fixing belt 42 in a contact manner. The fixing device 30 includes, at the outer periphery of the press roller 46, a press roller center thermistor 60 to detect the surface temperature of the center of the press roller 46 in a contact manner, and a press roller rear thermistor 61 to detect the surface temperature of the rear of the press roller 46 in a contact manner.

The fixing device 30 includes a center thermostat 62 and a rear thermostat 63 at the outer periphery of the fixing belt 42. The fixing device 30 includes a press roller thermostat 66 at the outer periphery of the press roller 46.

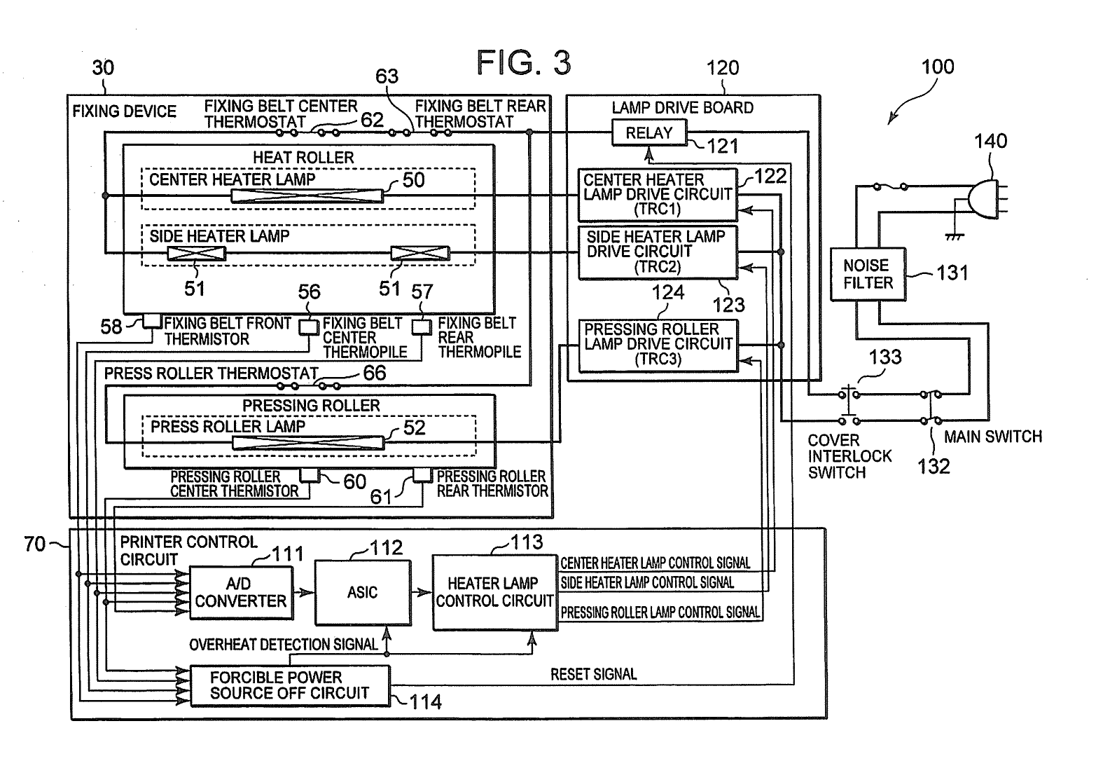

FIG. 3 is a block diagram showing a control system 100 which mainly relates to the temperature control of the fixing device 30. The control system 100 includes a printer control circuit 70 to control the whole color printer 1 including the fixing device 30. The control system 100 includes a lamp drive board 120 to control power applied to the center heater lamp 50, the side heater lamp 51 and the press roller lamp 52 of the fixing device 30 from a commercial alternate current power source (AC power source) 140. The control system 100 applies and controls up to 1200 W to the center heater lamp 50, the side heater lamp 51 and the press roller lamp 52 from the AC power source 140.

The printer control circuit 70 includes an A/D converter 111, an ASIC 112, a heater lamp control circuit 113 and a forcible power source off circuit 114. The lamp drive board 120 includes a relay 121, a center heater lamp drive circuit (TRC1) 122, a side heater lamp drive circuit (TRC2) 123 and a pressing roller lamp drive circuit (TRC3) 124. The AC power source 140 supplies electric power to the lamp drive board 120 through a noise filter 131, a main switch 132 and a cover interlock switch 133.

The control system 100 inputs detected temperatures from the center thermopile 56, the rear thermopile 57, the front thermistor 58, the center thermistor 60 and the rear thermistor 61 into the ASIC 112 through the A/D converter 111. The ASIC 112 sends control signals to the TRC1 122, the TRC2 123 and the TRC3 124 of the lamp drive board 120 through the heater lamp control circuit 113 based on the detected temperatures. The TRC1 122, the TRC2 123 and the TRC3 124 respectively control the power supply to the center heater lamp 50, the side heater lamp 51 and the press roller lamp 52 by the control signals from the heater lamp control circuit 113.

The forcible power source off circuit 114 sends an overheat detection signal to the ASIC 112 and the heater lamp control circuit 113 when the surface temperature of the fixing belt 42 or the press roller 46 exceeds a specified temperature and overheats. The forcible power source off circuit 114 sends a reset signal to the relay 121 when the surface temperature of the fixing belt 42 or the press roller 46 overheats. When receiving the reset signal, the relay 121 is forcibly turned off.

The center thermostat 62, the rear thermostat 63 and the press roller thermostat 66 interrupt power supply to the heater lamp when the control circuit does not function due to abnormality of, for example, the thermistor or the thermopile, and the fixing belt 42 or the press roller 46 is abnormally overheated.

FIG. 4 shows an example of control temperature of the fixing device 30 at the time of warm-up. For example, ready control temperature of the center and the side of the fixing belt 42 is 160° C., and ready control temperature of the press roller 46 is 130° C.

The ready control temperature of the fixing belt 42 and the ready control temperature of the press roller 46 have margins. For example, when the surface temperature of the center and the side of the fixing belt 42 is 150° C., and the surface temperature of the press roller 46 is 100° C., the fixing device 30 is in a ready displayable temperature. When the fixing device 30 is in the ready displayable temperature, the color printer 1 displays the ready on, for example, a touch panel.

At the time of warm-up, the copy temperature at which the control system 100 changes the driving of the side heater lamp 51 and the press roller lamp 52 from ON driving to ON and OFF continuously cycle driving is, for example, the ready displayable temperature or the ready control temperature.

The color printer 1 achieves excellent fixing performance when the fixing belt 42 and the press roller 46 keep the ready control temperature. However, in the color printer 1, when a print request is made, even if the fixing belt 42 and the press roller 46 do not reach the ready control temperature, when the ready is displayed (when the fixing belt 42 and the press roller 46 reach the ready displayable temperature), printing is possible. The upper limit control temperature of the center and the side of the fixing belt 42 is 180° C.

At the time of warm-up, when the heating speed of the press roller 46 is low as compared with the fixing belt 42, the fixing device 30 is on standby after the fixing belt 42 reaches the ready control temperature and until the press roller 46 reaches the ready control temperature. When both the fixing belt 42 and the press roller 46 reach the ready control temperature, the fixing device 30 finishes the warm-up.

[Warming-Up 1]

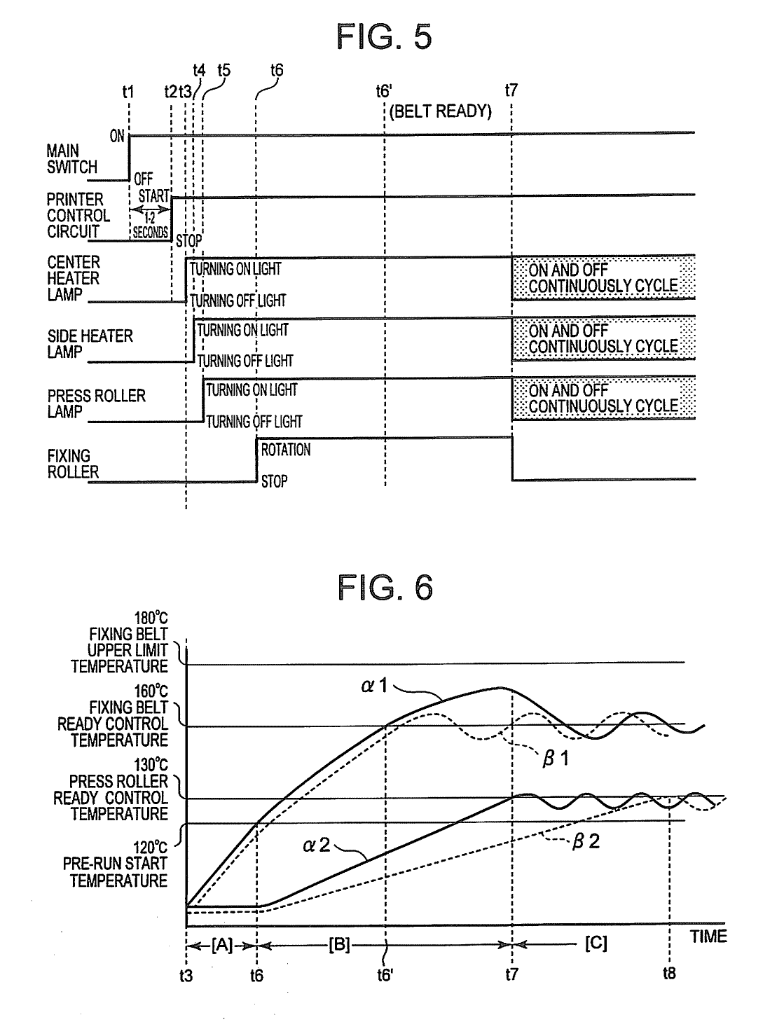

The control of the warming-up 1 of the fixing device 30 will be described. As shown in FIG. 5, (1) when an operator turns on the main switch 132 at time t1, the AC power source 140 supplies power to the control system 100. The printer control circuit 70 is activated at time t2, for example, one to two seconds later from the power supply. After being activated, the printer control circuit 70 starts to control the control system 100 of the fixing device 30.

(2) The control system 100 turns on the center heater lamp 50 at time t3, turns on the side heater lamp 51 at time t4, and turns on the press roller lamp 52 at time t5. The timings when the respective lamps are turned on are shifted to prevent plural rush currents generated in the respective lamps from being superimposed at the time of power supply start.

The control system 100 continues to turn on the center heater lamp 50, the side heater lamp 51 and the press roller lamp 52. (3) At time t6, when the control system 100 detects through the center thermopile 56 and the rear thermopile 57 that the fixing belt 42 reaches 120° C. of pre-run start temperature, the printer control circuit 70 drives to rotate and the fixing roller 40 in the arrow r direction. The fixing belt 42 rotates in the arrow r direction by the rotation of the fixing roller 40. The press roller 46, which is brought into press contact with the fixing belt 42, is driven and rotated in the arrow q direction.

(4) Even if the fixing belt 42 reaches the ready control temperature at time t6′, since the press roller 46 does not reach the ready control temperature, the control system 100 continues to turn on the press roller lamp 52, and continues to turn on the center heater lamp 50 and the side heater lamp 51. Since the center heater lamp 50 and the side heater lamp 51 are continued to be turned on, the temperature of the fixing belt 42 further rises. The fixing belt 42, which is in press contact with the press roller lamp 52 at the nip 47, heats the press roller 46 from the outside. The temperature rising speed of the press roller 46 is accelerated by heating from the outside by the contact with the fixing belt 42 and heating from the inside by the press roller lamp 51.

(5) At time t7, when it is detected, based on the temperature detection of the press roller 46 by the press roller center thermistor 60 and the press roller rear thermistor 61, that the press roller 46 reaches 130° C. of the ready control temperature, the fixing device 30 completes the warm-up. When the warm-up completes, the control system 30 changes the driving of the center heater lamp 50, the side heater lamp 51 and the press roller lamp 52 from the ON driving to the ON and OFF continuously cycle driving. At time t7, after the fixing belt 42 and the press roller 46 reach the ready control temperature, during a ready mode, the control system 100 drives the center heater lamp 50, the side heater lamp 51 and the press roller lamp 52 to cycle ON and OFF continuously, and keeps the fixing belt 42 and the press roller 46 at the ready control temperature. FIG. 6 shows the surface temperatures of the fixing belt 42 and the press roller 46 by the warming-up 1. In FIG. 6 a solid line α1 indicates the surface temperature of the fixing belt 42, and a solid line a2 indicates the surface temperature of the press roller 46.

A region [A] of FIG. 6 is from the time when the center heater lamp 50, the side heater lamp 51 and the press roller lamp 52 are turned on to the time t6. A region [B] is from the time t6 when the surface temperature of the fixing belt 42 reaches the pre-run start temperature to the time t7 when the surface temperature of the press roller 46 reaches the ready control temperature. A region [C] is a region after the driving of the center heater lamp 50, the side heater lamp 51 and the press roller lamp 52 is changed to the ON and OFF continuously cycle driving in the above (5).

In the region [A], the temperatures of the fixing belt 42 and the press roller 46 rise, and the temperature of the fixing belt 42 having a small heat capacity and a large heating electric power as compared with the press roller 46 rises earlier. In the region [B], the temperature rise of the fixing belt 42 becomes gentle. In the region [B], the fixing belt 42 reaches the ready temperature at time t6′ earlier than the press roller 46. In the region [B], the temperature of the fixing belt 42 exceeds the ready control temperature and further rises. The temperature of the press roller 46 quickly rises by heating from the fixing belt 42 the temperature of which rises and the press roller lamp 52, and reaches the ready control temperature. When the fixing belt 42 and the press roller 46 reach the respective ready control temperatures, the fixing device 30 completes the warm-up. In the region [C], after the temperature lowers to the ready control temperature, the fixing belt 42 keeps the ready control temperature, and the press roller 46 keeps the ready control temperature.

The control of the warming-up 1 is not limited to the warm-up after the main switch is turned on. For example, the control can be applied to warm-up control from a sleep mode in which power supply to the center heater lamp 50, the side heater lamp 51 and the press roller lamp 52 is interrupted.

### Comparative Example 1

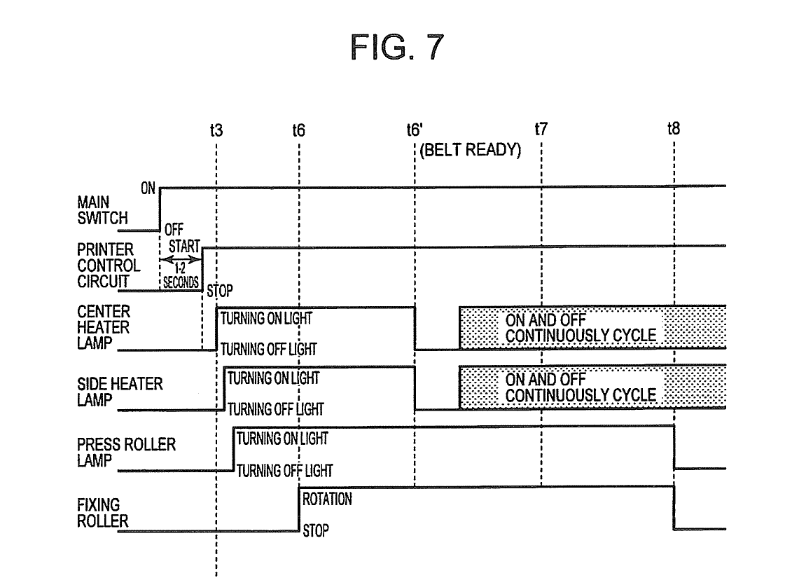

FIG. 7 shows warm-up control of comparative example 1. In the comparative example 1, after the center heater lamp 50, the side heater lamp 51 and the press roller lamp 52 are turned on, when the fixing belt 42 reaches the pre-run start temperature at time t6, the rotation of the fixing roller 40 starts. In the comparative example 1, at time t6′ when the fixing belt 42 reaches the ready control temperature, the on control of the press roller lamp 52 is continued. In the comparative example 1, at the time t6′, the driving of the center heater lamp 50 and the side heater lamp 51 is changed from the ON driving to the ON and OFF continuously cycle driving. In the comparative example 1, after the fixing belt 42 reaches the ready control temperature, the fixing belt 42 is kept at the ready control temperature.

The surface temperature values of the fixing belt 42 and the press roller 46 in the comparative example 1 are shown in FIG. 6 by dotted lines. A dotted line β1 indicates the surface temperature of the fixing belt 42, and a dotted line β2 indicates the surface temperature of the press roller 46. The surface temperatures of the fixing belt 42 and the press roller 46 of the comparative example 1 in the region [A] are the same as those of the warming-up 1.

The temperature rising speed of the press roller 46 in the region [B] and the region [C] in the comparative example 1 is quickened by heating from the fixing belt 42 and heating from the press roller lamp 52. However, in the warming-up 1, heating of the fixing belt 42 is further continued also after the fixing belt 42 reaches the ready control temperature, while in the comparative example 1, the fixing belt 42 is kept at the ready control temperature after the fixing belt 42 reaches the ready control temperature.

In the comparative example 1, as compared with the warming-up 1, the temperature of the fixing belt 42 in the region [B] and the region [C] are low. In the comparative example 1, as compared with the warming-up 1, the temperature rising speed of the press roller 46 in the region [B] and the region [C] is low. At time t7 when both the fixing belt 42 and the press roller 46 reach the ready control temperatures in the warming-up 1, in the comparative example 1, the surface temperature of the press roller 46 does not reach the ready control temperature. The time when the comparative example 1 reaches completion of the warm-up is later than the time when the warming-up 1 reaches completion of the warm-up. In the comparative example 1, at time t8 after time t7, both the fixing belt 42 and the press roller 46 reach the ready control temperatures, and the warm-up is completed.

In the warming-up 1, also after the fixing belt 42 reaches the ready control temperature at time t6′, the center heater lamp 50 and the side heater lamp 51 are continued to be turned on, and the amount of heat given to the press roller 46 from the outside becomes large. In the warming-up 1, the temperature rising speed of the press roller 46 after time t6′ is increased, and the time difference between the time when the fixing belt 42 reaches the ready control temperature and the time when the press roller 46 reaches the ready control temperature is shortened. In the warming-up 1, the time required for the warm-up of the fixing device 30 is shortened. In the warming-up 1, the time required for the warm-up is shortened, the power consumption at the time of the warm-up is saved, and the waiting time of the user is shortened.

[Warming-up 2]

The control of warming-up 2 of the fixing device 30 will be described. The warming-up 2 is the control for the case where after the fixing belt 42 reaches the ready control temperature in the warming-up 1, even when the fixing belt 42 reaches an upper limit temperature of the fixing belt 42, the press roller 46 does not reach the ready control temperature.

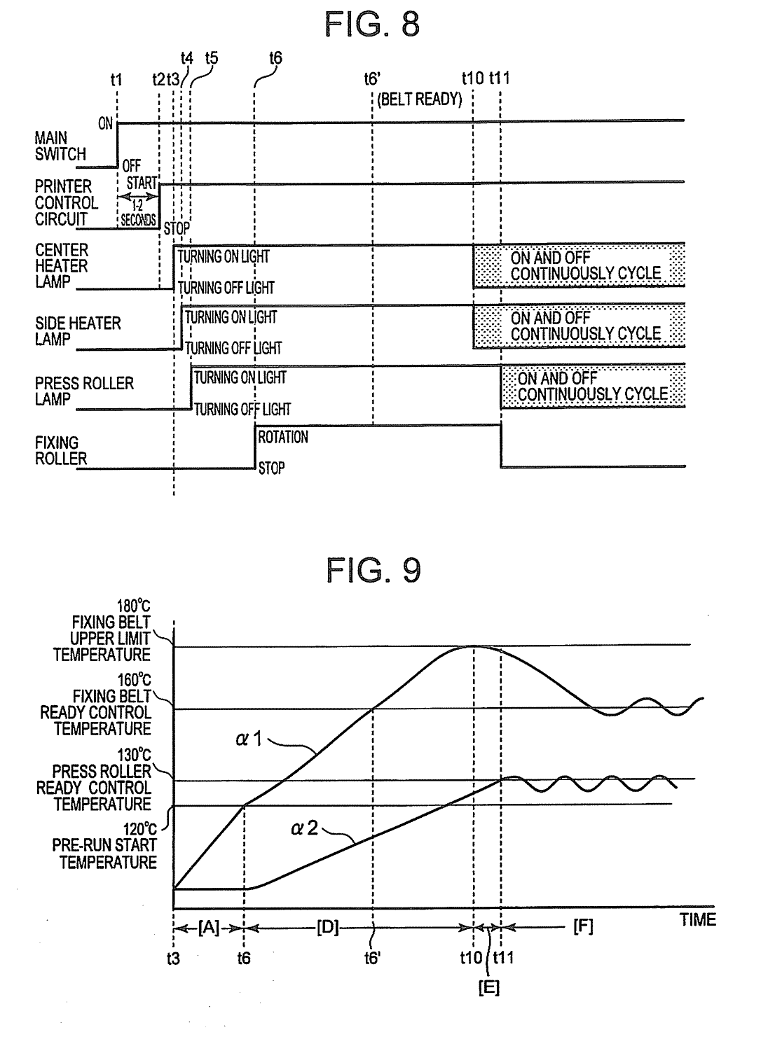

As shown in FIG. 8, in the warming-up 2, (6) after the main switch 132 is turned on at time t1, the control system 1 controls similarly to the warming-up 1 until the fixing belt 42 reaches the pre-run start temperature at time t6. (7) At time t6, when it is detected that the fixing belt 42 reaches the pre-run start temperature, the printer control circuit 70 drives to rotate and the fixing roller 40. Although the fixing belt 42 reaches the ready control temperature, the press roller 46 does not reach the ready control temperature. Thus, the control system 100 continues to turn on the press roller lamp 52, and continues to turn on the center heater lamp 50 and the side heater lamp 51.

(8) When the control system continues to turn on the center heater lamp 50 and the side heater lamp 51, the temperature of the fixing belt 42 further rises. The fixing belt 42 which is in press contact with the press roller lamp 52 at the nip 47 heats the press roller 46 from the outside. The temperature rising speed of the press roller lamp 46 is accelerated by heating from the outside by the contact with the fixing belt 42 and heating from the inside by the press roller lamp 51.

(9) When the surface temperature of the fixing belt 42 reaches the upper limit control temperature at time t10 before the press roller 46 reaches the ready control temperature, the control system 100 continues to turn on the press roller lamp 52, and changes driving of the center heater lamp 50 and the side heater lamp 51 from the ON driving to the ON and OFF continuously cycle driving. The control system 100 prevents that the surface temperature of the fixing belt 42 exceeds the upper limit control temperature and the fixing belt 42 is abnormally overheated.

(10) After the driving of the center heater lamp 50 and the side heater lamp 51 is changed to the ON and OFF continuously cycle driving at the upper limit control temperature, when it is detected at time t11 that the press roller 46 reaches 130° C. of the ready control temperature, the control system 100 completes the warm-up of the fixing device 30. By the completion of the warm-up, the control system 100 changes the driving of the press roller lamp 52 from the ON driving to the ON and OFF continuously cycle driving at the ready control temperature. The control system 100 changes the control temperature of the center heater lamp 50 and the side heater lamp 51 from the upper limit control temperature to the ready control temperature, and performs the ON and OFF continuously cycle driving. After completion of the warm-up, the control system 100 keeps the fixing belt 42 and the press roller 46 at the ready control temperature during a ready mode.

FIG. 9 shows surface temperature values of the fixing belt 42 and the press roller 46 in the warming-up 2. In FIG. 9, a solid line γ1 indicates the surface temperature of the fixing belt 42, and a solid line γ2 indicates the surface temperature of the press roller 46.

A region [A] of FIG. 9 is from the time when the center heater lamp 50, the side heater lamp 51 and the press roller lamp 52 are turned on to time t6. A region [D] is from the time t6 when the surface temperature of the fixing belt 42 reaches the pre-run start temperature to time t10 when the fixing belt 42 reaches the upper limit control temperature. A region [E] is from time t10 when the driving of the center heater lamp 50 and the side heater lamp 51 is changed to the ON and OFF continuously cycle driving to time t11 when the surface temperature of the press roller 46 reaches the ready control temperature. A region [F] is a region after the driving of the press roller lamp 52 is changed to the ON and OFF continuously cycle driving.

In the region [A], the temperature of the fixing belt and the press roller 46 rises similarly to the warming-up 1, and as compared with the press roller 46, the fixing belt 42 reaches the ready control temperature first. In the region [D], the fixing belt 42 exceeds the ready control temperature and the temperature further rises. The temperature of the press roller 46 rapidly rises by heating from the fixing belt 42 the temperature of which rises and the press roller lamp 52. In the region [D], before the press roller 46 reaches the ready control temperature, the fixing belt 42 reaches the upper limit control temperature. In the region [E], the fixing belt 42 keeps the upper limit control temperature. The press roller 46 reaches the ready control temperature by heating from the fixing belt 42 and the press roller lamp 52. In the region [F], after the temperature of the fixing belt 42 lowers to the ready control temperature, the fixing belt keeps the ready control temperature, and the press roller 46 keeps the ready control temperature.

In the warming-up 2, also after the fixing belt 42 reaches the ready control temperature at time t6′, similarly to the warming-up 1, the center heater lamp 50 and the side heater lamp 51 are continued to be turned on, so that the amount of heat given to the press roller 46 from the outside becomes large. In the warming-up 2, the temperature rising speed of the press roller 46 after time t6′ is increased to shorten the time difference between the time when the fixing belt 42 reaches the ready control temperature and the time when the press roller 46 reaches the ready control temperature. In the warming-up 2, the time required for warm-up of the fixing device 30 is shortened. In the warming-up 2, the time required for the warm-up is shortened, the power consumption at the time of the warm-up is saved, and the waiting time of the user is shortened.

In the warming-up 2, when the fixing belt 42 reaches the upper limit control temperature at time t10, even when the press roller 46 does not reach the ready control temperature, the driving of the center heater lamp 50 and the side heater lamp 51 is changed to the ON and OFF continuously cycle driving. In the warming-up 2, it is prevented that the surface temperature of the fixing belt 42 exceeds the upper limit control temperature, and the fixing belt is abnormally overheated. The time required for the warm-up is shortened, and the safety of the fixing device 30 is ensured.

According to this embodiment, also after the fixing belt 42 reaches the ready control temperature, the center heater lamp 50 and the side heater lamp 51 are continued to be turned on, so that the amount of heat given to the press roller 46 from the outside is increased, and the temperature rising speed of the press roller 46 is increased. According to this embodiment, the time difference between the time when the fixing belt 42 reaches the ready control temperature and the time when the press roller 46 reaches the ready control temperature is shortened, the time required for the warm-up of the fixing device 30 is shortened, the power consumption at the time of the warm-up is saved, and the waiting time of the user is shortened.

According to this embodiment, when the fixing belt 42 reaches the upper limit control temperature before the press roller 46 reaches the ready control temperature, the driving of the center heater lamp 50 and the side heater lamp 51 is changed from the ON driving to the ON and OFF continuously cycle driving. It is prevented that the fixing belt 42 is abnormally overheated, and the safety of the fixing device 30 is ensured.

While certain embodiments have been described these embodiments have been presented by way of example only, and are not intended to limit the scope of the inventions. Indeed, the novel apparatus and methods described herein may be embodied in a variety of other forms: furthermore various omissions, substitutions and changes in the form of the apparatus and methods described herein may be made without departing from the spirit of the inventions. The accompanying claims and there equivalents are intended to cover such forms of modifications as would fall within the scope and spirit of the invention.

What is claimed is:

1. A fixing device comprising:
a fixing body that contacts with a non-fixed toner on a recording medium;
a pressing body that forms a nip between the pressing body and the fixing body;
a first heater to heat the fixing body;
a second heater to heat the pressing body; and
a control part that applies maximum electric power to the first heater and the second heater until the pressing body reaches a copy temperature when, although the fixing body reaches a copy temperature, the pressing body does not reach the copy temperature.

2. The device of claim 1, wherein the control part controls the first heater and the second heater to ON and OFF continuously cycle driving, when the pressing body reaches the copy temperature.

3. The device of claim 1, wherein the copy temperature is a ready control temperature.

4. The device of claim 1, wherein the control part controls the first heater to ON and OFF continuously cycle driving, when the pressing body does not reach the copy temperature, and when the fixing body reaches a control upper limit temperature.

5. The device of claim 1, wherein the fixing body comprises an endless fixing belt and a plurality of rotators to support the belt, and the pressing body is a press roller.

6. The device of claim 5, wherein the plurality of rotators comprise a fixing roller to support the fixing belt at the nip and a heat roller heated by the first heater.

7. The device of claim 1, wherein the first heater comprises a first region heater and a second region heater different from the first region heater in region.

8. The device of claim 7, wherein the control part controls the first region heater and the second region heater to ON and OFF continuously cycle driving alternately and controls the second heater to ON and OFF continuously cycle driving, when the pressing body reaches the copy temperature.

9. An image forming apparatus comprising:
an image forming part to form an image on a recording medium;
a fixing body that contacts with a non-fixed toner on the recording medium;
a pressing body that forms a nip between the pressing body and the fixing body;
a first heater to heat the fixing body;
a second heater to heat the pressing body; and
a control part that controls and applies maximum electric power to the first heater and the second heater until the pressing body reaches a copy temperature when, although the fixing body reaches a copy temperature, the pressing body does not reach the copy temperature.

10. The apparatus of claim 9, wherein the control part controls the first heater and the second heater to ON and OFF continuously cycle driving, when the pressing body reaches the copy temperature.

11. The apparatus of claim 9, wherein the copy temperature is a ready control temperature.

12. The apparatus of claim 9, wherein the control part controls the first heater to ON and OFF continuously cycle driving, when the pressing body does not reach the copy temperature, and when the fixing body reaches a control upper limit temperature.

13. The apparatus of claim 9, wherein the fixing body comprises an endless fixing belt and a plurality of rotators to support the belt, and the pressing body is a press roller.

14. The apparatus of claim 13, wherein the plurality of rotators comprise a fixing roller to support the fixing belt at the nip and a heat roller heated by the first heater.

15. The apparatus of claim 9, wherein the first heater comprises a first region heater and a second region heater different from the first region heater in region, and the control part controls the first region heater and the second region heater to ON and OFF continuously cycle driving alternately and controls the second heater to ON and OFF continuously cycle driving, when the pressing body reaches the copy temperature.

16. A fixing control method, comprising:
applying maximum electric power to a first heater and a second heater by turning on a power source; and
continuing to apply the maximum electric power to the first heater and the second heater when, although a fixing body heated by the first heater reaches a copy temperature, a pressing body heated by the second heater does not reach a copy temperature.

17. The method of claim 16, further comprising controlling an application of electric power to the first heater to cycle ON and OFF continuously and controlling an application of electric power to the second heater to cycle ON and OFF continuously, when the pressing body reaches the copy temperature.

18. The method of claim 16, wherein the copy temperature is a ready control temperature.

19. The method of claim 16, further comprising controlling an application of electric power to the first heater to cycle ON and OFF continuously, when the pressing body does not reach the copy temperature, and when the fixing body reaches a control upper limit temperature.

20. The method of claim 19, wherein the first heater comprises a first region heater and a second region heater different from the first region heater in region, and further comprising controlling an application of electric power to the first region heater and the second region heater alternately to cycle ON and OFF continuously and controlling an application of electric power to the second heater to cycle ON and OFF continuously, when the pressing body reaches the copy temperature.
